(19) United States
(12) Patent Application Publication
(10) Pub. No.: US 2008/0240503 A1
(43) Pub. Date: Oct. 2, 2008

(54) Image Processing Apparatus And Image Pickup Apparatus Mounting The Same, And Image Processing Method

(75) Inventors: Shigeyuki Okada, Ogaki-shi (JP); Tsugio Mori, Ibi-gun (JP); Hideto Fujita, Yao-City (JP); Akihiko Yamada, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: Sanyo Electric Co., Ltd., Moriguchi-shi (JP)

(21) Appl. No.: 12/056,822

(22) Filed: Mar. 27, 2008

(30) Foreign Application Priority Data
Mar. 30, 2007 (JP) JP2007-093405
Feb. 27, 2008 (JP) JP2008-046561
Feb. 27, 2008 (JP) JP2008-046562

(51) Int. Cl. G06K 9/00

(52) U.S. Cl. 382/103

(57) ABSTRACT

A coding unit codes a moving image. An object detector detects an object from within a picture contained in the moving image, and generates, for each picture, object detection information containing at least the number of objects detected within an identical picture. When a codestream is generated from coded data generated by the coding unit, a stream generator describes the object detection information in a prescribed region of the codestream.

### CROSS-REFERENCE TO RELATED APPLICATIONS

This application is based upon and claims the benefit of priority from the prior Japanese Patent Applications No. 2007-093405, filed Mar. 30, 2007, Japanese Patent Applications No. 2008-046561, filed Feb. 27, 2008, and Japanese Patent Application No. 2008-046562, filed Feb. 27, 2008, the entire contents of which are incorporated herein by reference.

### BACKGROUND OF THE INVENTION

1. Field of the Invention

The present invention relates to an image processing apparatus capable of detecting a specific object such as a face, an image pickup apparatus mounting said image processing apparatus, and an image processing method.

2. Description of the Related Art

Digital video cameras have been widely in use and average users can easily take moving pictures more readily than ever before. The average users often take pictures of persons such as children in athletic festivals or the like.

A technique for detecting a specific object such as a face is used to optimize a recording capacity or the control of auto-focusing. The inventors of the present invention had found an effective use of the object detection technique in applications other than the above use.

### SUMMARY OF THE INVENTION

An image processing apparatus according to one embodiment of the present invention comprises: a coding unit which codes a moving image; a stream generator which generates a codestream from coded data generated by the coding unit; and an object detector which detects a specific object from within a picture contained in the moving image and which generates, for each picture, object detection information containing at least the number of objects detected within an identical picture. The stream generator describes the object detection information in a predetermined region of the codestream.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 illustrates a structure of an image pickup apparatus according to a first embodiment of the present invention;

FIG. 2A illustrates an example where the position of frames that satisfy a predetermined search condition is searched; FIG. 2B illustrates an example where the number of faces within an image is simply displayed; and FIG. 2C illustrates an example where the number of faces within an image is displayed in a manner that it is classified into the number of frontal faces and that of side faces;

FIG. 3 illustrates a first display example in an image pickup apparatus according to a first embodiment of the present invention;

FIG. 4 illustrates a second display example in an image pickup apparatus according to a first embodiment of the present invention;

FIG. 5 illustrates a third display example in an image pickup apparatus according to a first embodiment of the present invention; and

FIG. 6 illustrates a structure of an image pickup apparatus according to a second embodiment of the present invention;

FIG. 7 illustrates a structure of an image playback apparatus according to a third embodiment of the present invention;

FIG. 8 illustrates an example where face detection information containing a plurality of parameters is generated from images picked up by image pickup apparatuses according to a first and a second embodiment;

FIG. 9 illustrates an example of an operation screen displayed on a display unit of image pickup apparatuses according to a first and a second embodiment or a display unit of an image playback apparatus according to a third embodiment; and

FIG. 10 illustrates an example of a digest setting screen displayed on a display unit of image pickup apparatuses according to a first and a second embodiment or a display unit of an image playback apparatus according to a third embodiment.

### DETAILED DESCRIPTION OF THE INVENTION

The invention will now be described by reference to the preferred embodiments. This does not intend to limit the scope of the present invention, but to exemplify the invention.

A description of a typical embodiment will be given before describing a detailed description of embodiments of the present invention. An image processing apparatus according to one embodiment of the present invention comprises: a coding unit which codes a moving image; a stream generator which generates a codestream from coded data generated by the coding unit; and an object detector which detects a specific object from within a picture contained in the moving image and which generates, for each picture, object detection information containing at least the number of objects detected within an identical picture. The number of objects includes none, one or greater. The stream generator describes the object detection information in a predetermined region of the codestream. “Picture” means a unit of coding, and the concept thereof may include a frame, a field, a VOP (Video Object Plane) and the like. The “specific object” may be a face of a person, a face of an animal other than humans, an object such as an automobile, or the like.

According to this embodiment, the object detection information is described within a codestream. Thus, effective applications such as search processing can be achieved by using this object detection information.

The object detector may have at least one of a size of the object, a position of the object, the presence or absence of redundant data for use in super-resolution processing, information on whether a user registered object is detected or not, and a likelihood of the detected object contained in the object detection information, in addition to the number of objects. For example, a face of a specific person or a face of a pet animal and the like correspond to the user registered objects.

If the above-described specific object is a face, the object detector may have the number of faces detected as the object, contained in the object detection information separately for frontal face and side face. Here, if the face is set as a face of a person, it will be counted as such if it is the face of a person whoever he/she is.

If the above-described specific object is a face, the object detector may have a smile level of the face detected as the object, contained in the object detection information, in addition to the number of faces detected as the object.

The stream generator may describe the object detection information in a header area or an area, where a write by a user is permitted, of a corresponding picture in the codestream. When the number of objects contained in the object detection information varies, the stream generator may describe the object detection information in a header area or an area, where a write by a user is permitted, of a corresponding picture in the codestream; and when the number of objects contained in the object detection information does not vary, the stream generator may skip the describing. According to this embodiment, the capacity required for the addition of the object detection information can be reduced.

Another embodiment of the present invention relates also to an image processing apparatus. This apparatus comprises: a coding unit which codes a moving image; an object detector which detects a specific object from within a picture contained in the moving image and which generates, for each picture, object detection information containing at least the number of objects detected within an identical picture; and a file generator which generates a moving-image file from coded data generated by the coding unit and generates an object detection information file, differing from the moving-image file, from the object detection information generated by the object detector.

According to this embodiment, the generation of the object detection information file achieves effective applications, such as search processing, by using this generated file.

Still another embodiment of the present invention relates to an image pickup apparatus. This apparatus comprises: an image pickup device which picks up a moving image; and an image processing unit, according to any one of the above-described embodiments, which processes the moving image picked up by the image pickup device.

According to this embodiment, an image pickup apparatus achieving effective applications such as search processing can be structured.

An apparatus may further comprise a display unit which displays the moving image processed by the above-described image processing unit and a control unit which displays a picture contained in the moving image and the object detection information corresponding to said picture on the display unit in such a manner that the picture and the object detection information are associated with each other. The control unit may display them in a manner that associates a picture to be displayed with the number of objects detected. This arrangement enables the user to support a search task.

An apparatus may further comprise a control unit which searches for a picture that meets a specified condition by referring to the object detection information. This arranges can enhance the search efficiency.

Another embodiment of the present invention relates also to an image processing apparatus. This apparatus is an image processing apparatus for decoding a coded moving image and displaying the decoded image, comprises: a control unit which acquires object detection information, generated for each picture, on a specific object detected within a picture contained in the moving image and which generates a display in a manner that the picture containing the object is identifiable on a temporal axis of the moving image, based on the object detection information; and a display unit which displays the display generated by the control unit, within a screen. The object detection information may be generated when the moving images are coded or decoded.

The object detection information contains at least one of the number of objects detected within the same picture, the size of an object, the position of an object, the presence or absence of redundant data for use in super-resolution processing performed on an object, the smile level of an object (if the object is set as a face), information on whether a user registered object is detected or not, and the likelihood of the detected object.

When the number of objects detected within the same picture is contained in the object detection information, the control unit may generate the display in a manner that a position in which the number of objects varies is identifiable on the temporal axis of the moving image. For example, the entire playback time of the moving image may be displayed using a bar, and an index may be displayed at a position in which the number of objects varies. Also, the number of objects may be displayed near the index. If the object is persons and the number of faces are recorded in a manner that the frontal face and the side face thereof are recorded separately, the index and the number of faces may be displayed for the frontal face and the side face, respectively.

When the size of an object detected within a picture is contained in the object detection information, the control unit may generate the display in a manner that a position of a picture in which the size of the object is greater than a predetermined set value is identifiable on the temporal axis of the moving image. For example, the entire playback time of the moving image may be displayed using a bar, and an index may be displayed at a position of a picture in which the size of the object is larger than the predetermined set value. The predetermined set value may be adjusted by the user.

When information on whether or not a user registered object is detected within a picture is contained in the object detection information, the control unit may generate the display in a manner that a position in which the user registered object has been detected is identifiable on the temporal axis of the moving image. For example, the entire playback time of the moving image may be displayed using a bar, and an index may be displayed at a position in which the object has been detected.

When the presence or absence of redundant data for use in super-resolution processing of an object detected within a picture is contained in the object detection information, the control unit may generate the display in a manner that a position of a picture in which the super-resolution processing using the redundant data is possible is identifiable on the temporal axis of the moving image. For example, the entire playback time of the moving image may be displayed using a bar, and an index may be displayed at a position of a picture in which the super-resolution processing using the redundant data is possible. If pictures continue where the super-resolution processing using the redundant data is possible, those portions are displayed above the bar by using a color differing from that of other portions.

When the position of an object detected within a picture is contained in the object detection information, the control unit may generate the display in a manner that the position of a picture in which the position of the object is contained in a predetermined region (e.g., a center region of a screen) is identifiable on the temporal axis of the moving image. For example, the entire playback time of the moving image may be displayed using a bar, and an index may be displayed at a position of a picture in which the position of the object is contained in the predetermined region. The predetermined region may be adjusted by the user.

When the smile level of an object detected within a picture is contained in the object detection information, the control unit may generate the display in a manner that a position of a picture in which the smile level of the object is higher than a predetermined set value is identifiable on the temporal axis of the moving image. For example, the entire playback time of the moving image may be displayed using a bar, and an index may be displayed at a position of a picture in which the smile level of the object is higher than the predetermined set value. The predetermined set value may be adjusted by the user.

When the likelihood of an object detected within a picture is contained in the object detection information, the control unit may generate the display in a manner that a position of a picture in which the likelihood of the object is higher than a predetermined set value is identifiable on the temporal axis of the moving image. For example, the entire playback time of the moving image may be displayed using a bar, and an index may be displayed at a position of a picture in which the likelihood of the object is higher than the predetermined set value. The predetermined set value may be adjusted by the user.

According to these embodiments, an image that the user wishes to view can be easily searched. If the selection of the above-described index is designed to be jumped to the position of a picture in question, selecting the index by the user can easily reach the image that he/she wishes to view.

Still another embodiment of the present invention relates to an image processing apparatus. This apparatus is an apparatus for decoding a coded moving image and displaying the decoded image, and it comprises: a control unit which acquires object detection information, generated for each picture, on a specific object detected within a picture contained in the moving image and which generates a digest of the moving image, based on the object detection information; and a display unit which reproduces and displays the digest generated by the control unit.

The object detection information contains at least one of the number of objects detected within the same picture, the size of an object, the position of an object, the presence or absence of redundant data for use in super-resolution processing of an object, the smile level of an object (if the object is set as a face), information on whether a user registered object is detected or not, and the likelihood of the detected object.

In a case when the number of objects detected within the same picture is contained in the object detection information and when the control unit extracts pictures for digest playback from the moving image at a compression ratio set, the control unit may extract pictures the number of which corresponds to the compression ratio, from an upper level of pictures having a large number of objects. The above ratio may be adjusted by the user. For example, if the ratio is set to ½, a moving image digest whose playback time is a half of the playback time of the entire moving image is generated.

In a case when the size of an object detected within the picture is contained in the object detection information and when the control unit extracts pictures for digest playback from the moving images at a compression ratio set, the control unit may extract pictures the number of which corresponds to the compression ratio, from an upper level of pictures having relatively large objects, respectively. The above ratio may be adjusted by the user.

When information on whether or not a user registered object is detected within a picture is contained in the object detection information, the control unit may extract pictures where the object has been detected, from the moving image and then connect the pictures together so as to generate a moving image digest.

When the presence or absence of redundant data for use in super-resolution processing of an object detected within a picture is contained in the object detection information, the control unit may extract, from the moving image, pictures to which the super-resolution processing using the redundant data can be performed, and has the extracted pictures undergo the super-resolution processing. Then the control unit may connect those pictures together to generate a moving image digest.

In a case when the position of an object detected within a picture is contained in the object detection information and when the control unit extracts pictures for digest playback from the moving images at a compression ratio set, the control unit may extract pictures the number of which corresponds to the compression ratio, from an upper level of pictures close to a predetermined position of the screen. The above ratio may be adjusted by the user. The predetermined position may be the center of the screen.

When the position of an object detected within a picture is contained in the object detection information, the control unit may identify a difference in the object position between adjacent pictures, as the motion of the object. And when pictures for digest playback are extracted from the moving image at the compression ratio set, the control unit may extract pictures the number of which corresponds to the compression ratio, from an upper level of pictures whose motion of the object in relation to previous pictures is relatively larger. The above ratio may be adjusted by the user.

In a case when the smile level of an object detected within a picture is contained in the object detection information and when the control unit extracts pictures for digest playback from the moving images at a compression ratio set, the control unit may extract, from the moving images, pictures the number of which corresponds to the compression ratio set, from an upper level of pictures of the object having a high smile level. The above ratio may be adjusted by the user.

In a case when the likelihood of an object detected within a picture is contained in the object detection information and when the control unit extracts pictures for digest playback from the moving image at a compression ratio set, the control unit may extract, from the moving image, pictures the number of which corresponds to the compression ratio set, from an upper level of pictures of the objects having a high likelihood. The above ratio may be adjusted by the user.

It is to be noted that each of the digests generated using a plurality of parameters contained in the object detection information may be subjected to a logical operation with an AND condition or an OR condition, and those digests obtained after the logical operation may be the final digest. The above-mentioned compression ratio used may be different for each of the parameters.

According to these embodiments, a digest including images that the user wishes to view can be easily generated. Further, a variety of customizations may be done, so that the digest reflecting the user's taste can be easily produced.

Still another embodiment of the present invention relates to an image processing method. This method is such that when a codestream is generated by coding a moving image, a specific object is detected from within a picture contained in the moving image, object detection information is generated, for each picture, based on the specific object detected, and the object detection information is recorded in the codestream or in a manner that associates it with the codestream.

According to this embodiment, effective applications, such as search processing, can be achieved by using the object detection information.

Still another embodiment of the present invention relates also to an image processing method. This method is such that a picture satisfying a predetermined condition is searched from a moving image by use of object detection information specified for each picture. The object detection information may contain the number of object detections, and a picture for which the number of objects are associated with the number of designated objects may be searched.

According to this embodiment, the search is conducted using the object detection information, so that the search efficiency can be improved.

Arbitrary combinations of the aforementioned constituting elements, and the implementation of the present invention in the form of a method, an apparatus, a system, a medium, a program and so forth may also be effective as and encompassed by the embodiments of the present invention.

A description is given below of an example where a technique of detecting the face of a person as a specific object is used. Note that an object to be detected is not limited to the human faces and, for example, the technique used here is applicable to faces of pet animals like dogs or cats, objects like automobiles, electric trains and ships, and so forth.

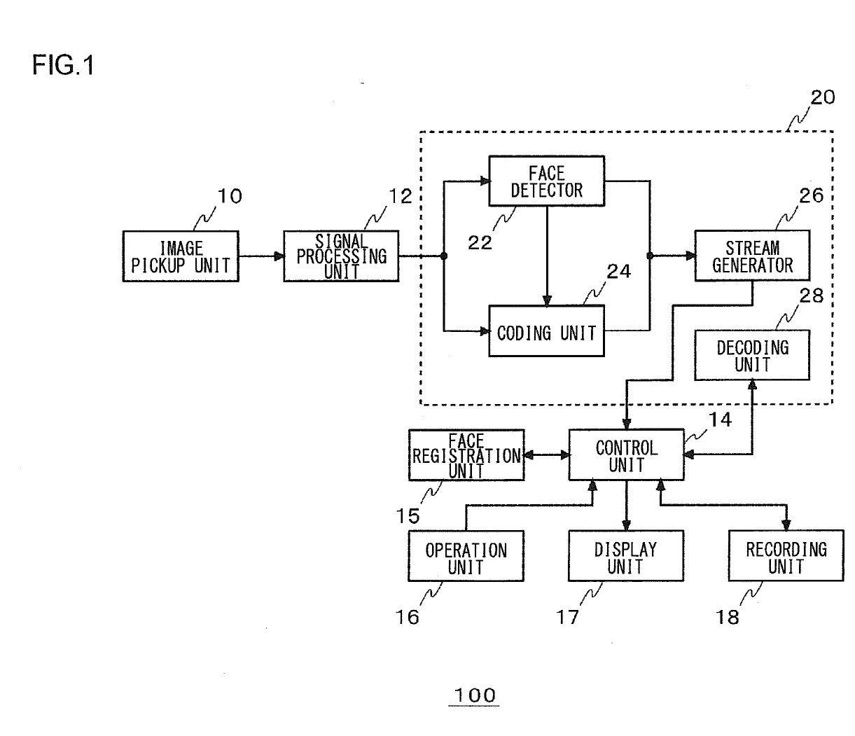

FIG. 1 illustrates a structure of an image pickup apparatus 100 according to a first embodiment of the present invention. The image pickup apparatus 100 according to the first embodiment includes an image pickup unit 10, a signal processing unit 12, an image processing unit 20, a control unit 14, a face registration unit 15, an operation unit 16, a display unit 17, and a recording unit 18. The image processing unit 20 includes a face detector 22, a coding unit 24, a stream generator 26, and a decoding unit 28. The structure of the image processing unit 20 may be implemented hardwarewise by elements such as a CPU, memory and other LSIs of an arbitrary computer, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

The image pickup unit 10, which includes image pickup devices such as CCD (Charge-Coupled Devices) sensors and CMOS (Complementary Metal-Oxide Semiconductor) image sensors, converts images picked up by the image pickup devices into electric signals and outputs them to the signal processing unit 12.

The signal processing unit 12 converts an RGB-formatted analog signal outputted from the image pickup unit 10 into a YUV-formatted digital signal. The signal processing unit 12 outputs the image signal after conversion, in units of frame, to the face detector 22 and the coding unit 24 in parallel.

The face detector 22 detects the face of a person from within an image inputted from the signal processing unit 12. The face detection may be done using a known method and no particular method is required. For example, an edge detection method, a boosting method, a hue extraction method or skin color extraction method may be used for the face detection method.

In the edge detection method, various edge features are extracted from a face region including eyes, nose, mouth and the contour of a face in a face image where the size of a face or a gray value thereof is normalized. A feature quantity which is effective in identifying whether an object is a face or not is learned based on a statistical technique. In this manner, a face discriminator is constructed.

To detect a face from within the input image, the similar feature quantity is extracted while raster scanning is performed, with the size of face normalized at the time of learning, starting from an edge of the input image. From this feature quantity, the face discriminator determines whether the region is a face or not. For example, a horizontal edge, a vertical edge, a diagonal right edge, a diagonal left edge and the like are each used as the feature quantity. If the face is not detected at all, the input image is reduced by a certain ratio, and the reduced image is raster-scanned similarly to the above to detect a face. Repeating such a processing leads to finding a face of arbitrary size from within the image.

If faster processing is desired but the accuracy is lower than the accuracy achieved using the edge detection method, the boosting method may be used. In the boosting method, edges are not used, and the face is extracted from an image in a manner that the shadowing of face including eyes and nose is compared with the shadowing of face detection patterns enrolled beforehand.

Other face detection methods which may also be used include the following methods. That is, a method may be such that a face candidate region is extracted, this face candidate region is divided into smaller regions, and the feature quantity of each of the small regions is compared with a preset face region pattern so as to extract a face region from the likelihood or accuracy thereof. A method may be such that face candidate regions are extracted and the likelihood or accuracy thereof is evaluated from the degree of overlapping of their respective regions so as to extract a face region. Further, the following method may be used. That is, if the face candidate regions are extracted and the density of each candidate region is equal to a value associated with a predetermined threshold value, the likelihood or accuracy thereof will be evaluated by the use of the density or chroma saturation contrast of the face candidate regions or body candidate regions so as to extract a face region.

If the face detector 22 detects one or more faces from within each frame, it will output the number of faces detected and the identification information on the frame from which the face has been detected, to the stream generator 26 as face detection information. A position at which the face has been detected may also be contained in the face detection information. It is to be noted that the face detection processing may be performed on all frames or every some frames.

The face detector 22 can detect a frontal face and a side face in a manner that they can be distinguished from each other. The frontal face and the side face can be classified if a frontal face pattern showing the both eyes and a side face pattern showing one eye only are enrolled beforehand as dictionary registration data.

If the face detector 22 detects any of user registration patterns, which have been enrolled beforehand by the user, in each frame, the face detector 22 will output the information thereof to the stream generator 26 and, at the same time, output the position of the user registration pattern within the frame to the coding unit 24.

The coding unit 24 codes the image signals inputted from the signal processing unit 12 in compliance with a predetermined standard. For instance, the moving images are coded in compliance with MPEG series standards (MPEG-1, MPEG-2 and MPEG-4) standardized by the International Organization for Standardization (ISO)/International Electrotechnical Commission (IEC), H.26x series standards (H.261, H.262 and H.263) standardized by the International Telecommunication Union-Telecommunication Standardization Sector (ITU-T) or H.264/AVC which is standardized in cooperation with each standardization organization (where the formal recommendations by the both organizations are called MPEG-4 Part 10: Advanced Video Coding and H.264, respectively). The coding unit 24 outputs compressed and coded image signals to the stream generator 26.

If a user registration pattern is detected by the face detector 22, the coding unit 24 will track the user registration pattern within a frame by referring to the positional information inputted from the face detector 22. It is to be noted that an image signal having a pixel region larger than the pixel region with the number of pixels to be recorded may be inputted to the coding unit 24. An extra region in this pixel region may be a region used for the correction of a camera shake. In such a case, if the above-described user registration pattern strays from a pixel region for use in recording, the coding unit 24 will use the extra region and move the recording pixel region so that the user registration pattern can be contained in the recording pixel region. If the user registration pattern is still in a position strayed therefrom after the movement, the recording pixel region is so moved as to contain the largest number of pixels that constitute the user registration pattern.

The stream generator 26 superposes the face detection information inputted from the face detector 22, on the MPEG-format coded data inputted from the coding unit 24 so as to generate a codestream. For instance, the face detection information on a corresponding frame is described in a header region of each frame, a region provided for describing function expanding information, comments or the like placed after the header region, and so forth. Instead of per frame, the information may be described all together in the header region or the like of a stream, sequence or GOP. Or, it may be described in units of slice or macroblock.

Instead of identifying the face detection information for each frame, the stream generator 26 may determine a content to be described, based on the information indicating that there is a change in this face detection information. For example, the number of face detections, namely the number of faces detected, is described in the frame where the face is first detected and then, for the frames during a period while the number of face detections does not change, the face detection information is not described therein. If a frame where the number of face detections changes appears, the number of face detections will be described in said frame. The same procedure as above continues. With this processing explained as above, the data amount can be reduced as compared with a case where the face detection information is identified for all of the frames and the identified face detection information is described in any of regions for each frame.

The stream generator 26 multiplexes video streams and audio streams by synchronizing them so as to generate MPEG-2 program streams or MPG-2 transport streams, and outputs the thus generated streams to the control unit 14.

The face registration unit 15 enrolls the above-described user registration pattern, which is to be recognized as a particular face pattern by the face detector 22, in the face detector 22 via the control unit 14. For example, using the image pickup unit 10, the image of a child's face can be picked up and enrolled. The operation unit 16 includes various types of buttons such as a shutter button. The user operates on the operation unit 16, so that he/she can send and assign search conditions, described later, to the control unit 14.

The display unit 17 displays images, which are being picked up or have been recorded in the recording unit 18, and displays various setting screens, various status information or the like. According to the present embodiment, as will be described later, the display unit 17 displays them on the screen of moving images which are being picked up or played back in a manner that associates them with the face detection information such as the number of faces. The recording unit 18, which is provided with a memory card slot, an optical disk or an HDD, records the picked-up images on a recording medium.

The control unit 14 controls the image pickup apparatus 100 in its entirety. In the present embodiment, the following processing is mainly performed. When the moving image being picked up or that being played back is displayed on the display unit 17, a codestream to be displayed is delivered to the decoding unit 28 so as to be decoded there. At this time, the face detection information extracted by the decoding unit 28 is decoded, and this face detection information is added to the image to be displayed and then displayed.

When the image pickup apparatus 100 is equipped with a function of extracting a frame selected by the user from the reproduced moving images as a still image file and when this selected frame is a frame which has been inter-frame coded, all of reference frames for this frame are extracted and the selected frame is reconstructed as a JPEG (Joint Photographic Expert Group) file, for instance.

A description is now given of a method for utilizing the face detection information in the image pickup apparatus 100 according to the present embodiment. A basic search method and a display method are described first.

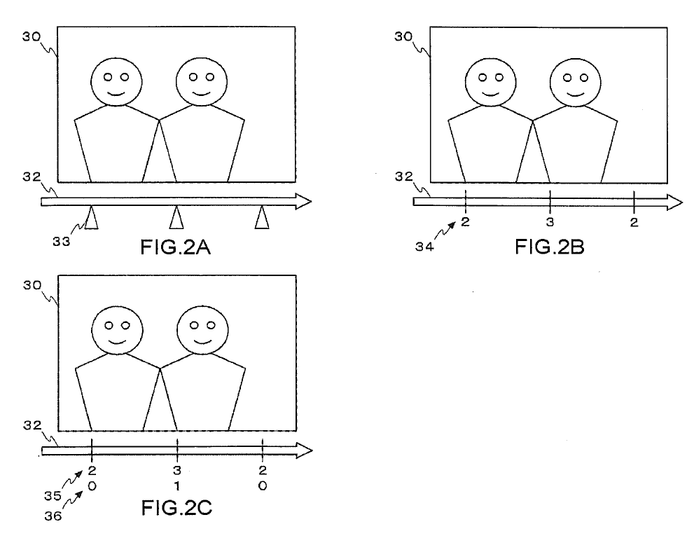

FIG. 2A illustrates an example where the position of frames that meet a predetermined condition is searched. When displaying the moving image on the display unit 17, the control unit 14 displays a time-elapsed bar 32 indicating the time elapsed, under a display area 30 of the moving image, in an aligned manner. In the example shown in FIGS. 2A to 2C, the rightmost state of the time-elapsed bar 32, namely the most preceding image in time, is displayed in the display area 30 of the moving images. An arrow 33 displayed below the time-elapsed bar 32 is an index display that indicates the position of a frame that has met the predetermined search condition. For example, the predetermined search condition may be so specified as to search a frame where the number of faces has been changed or a frame where the above-described user registration pattern has been detected. FIG. 2A illustrates an example where the search condition is so specified as to search the position of a frame for which the number of faces has been changed. And this example shows that the number of faces has been changed three times as time elapses.

FIG. 2B illustrates an example where the number of faces within an image is simply displayed. First numerals 34 displayed under the time-elapsed bar 32 indicate the number of faces detected at each frame. In the example shown in FIG. 2B, as time elapses, the number of faces transits in the order of 2→3→2, and “2” is maintained at present.

FIG. 2C illustrates an example where the number of faces within an image is displayed in a manner that it is classified into the number of frontal faces and that of side faces. Second numerals 35 displayed under the time-elapsed bar 32 indicate the number of frontal faces detected at each frame. Third numerals 36 displayed under the second numerals 35 indicate the number of side faces detected at each frame. In the example shown in FIG. 2C, as time elapses, the number of frontal faces transits in the order of 2→3→2, and “2” is maintained at present. Also, the number of side faces transits in the order of 0→1→0, and “0” is maintained at present. The total number of faces and the number of side faces may be displayed. Or the number of frontal faces, the number of side faces and the total number of frontal faces and side faces may be all displayed.

A description is given below of a method for displaying the face detection information using more specific examples.

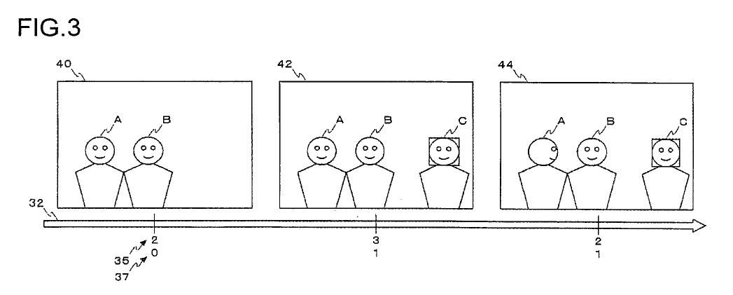

FIG. 3 illustrates a first display example in the image pickup apparatus 100 according to the first embodiment of the present invention. FIG. 3 shows a display screen indicating a frame-by-frame advance. As time elapses, the moving image transits in the order of a first image 40→a second image 42→a third image 44. As described above, the second numerals 35 displayed under the time-elapsed bar 32 indicate the number of frontal faces detected at each frame. Fourth numerals 37 indicate the number of detections for a user registration pattern, namely the number of the user registration patterns detected.

In the first image 40, the images of two persons A and B are picked up and the image of a person C identified by the user registration pattern is not picked up. As a result, the second numerals 35 indicate “2” and the fourth numerals 37 indicate “0”. In the second image 42, the person C identified by the user registration pattern enters. As a result, the second numerals 35 indicate “3” and the fourth numerals 37 indicate “1”. In the third image 44, the person A turns his/her head away. As a result, the second numerals 35 indicate “2” and the fourth numerals 37 indicate “1”.

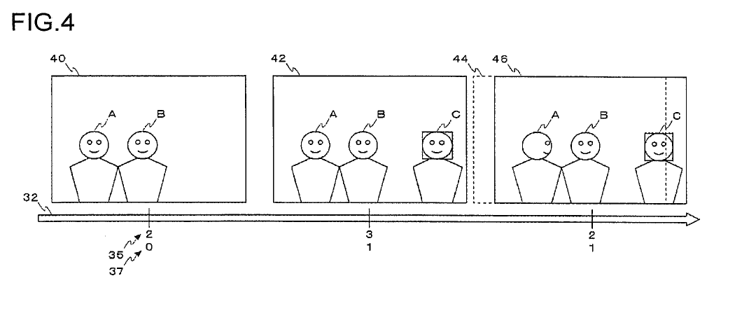

FIG. 4 illustrates a second display example in the image pickup apparatus 100 according to the first embodiment. Similar to the first display example, the images of two persons A and B are picked up in the first image 40 and the image of the person C specified by the user registration pattern is not picked up. As a result, the second numerals 35 indicate “2” and the fourth numerals 37 indicate “0”. In the second image 42, the person C identified by the user registration pattern enters. As a result, the second numerals 35 indicate “3” and the fourth numerals 37 indicate “1”.

In the third image 44 having a pixel region enclosed by dotted lines, part of right side of the body of the person C is cut off. If the face of the person C falls under the category of a user registration pattern, the coding unit 24 will receive the positional information on the face of the person C from the face detector 22 and track the face of the person C. The coding unit 24 moves the pixel region for use in recording, to the right so that the face of the person C lies within the pixel region for use in recording. A fourth image 46 is an image having a pixel region after the movement. The image which is actually recorded and displayed is not the third image 44 but the fourth image 46. In the fourth image 46, the person A turns his/her head away and the person C remains in the image, so that the second numerals 35 indicate “2” and the fourth numerals 37 indicate “1”.

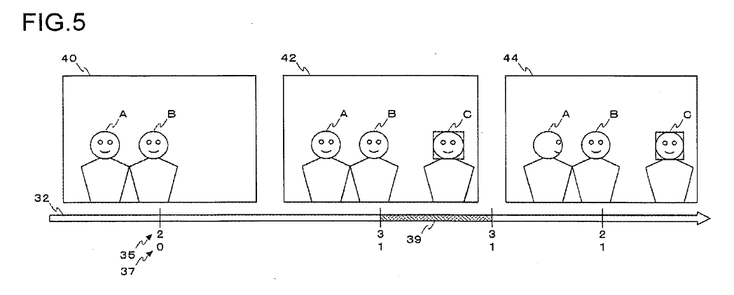

FIG. 5 illustrates a third display example in the image pickup apparatus 100 according to the first embodiment. Similar to the first display example, the images of two persons A and B are picked up in the first image 40 and the image of the person C specified by the user registration pattern is not picked up. As a result, the second numerals indicate “2” and the fourth numerals 37 indicate “0”. In the second image 42, the person C identified by the user registration pattern enters. As a result, the second numerals 35 indicate “3” and the fourth numerals 37 indicate “1”. In the third image 44, the person A turns his/her head away. As a result, the second numerals 35 indicate “2” and the fourth numerals 37 indicate “1”.

Designating a search condition from the operation unit 16 allows the user to search for a frame or scene, which meets a predetermined condition, from within the moving image. FIG. 5 is an example where it is designated to search for a frame or scene having three or more frontal faces. A period 39 marked with oblique lines in the time-elapsed bar 32 is the period that satisfies the search condition.

According to the present embodiment explained as above, effective applications can be achieved by using the face detection information. That is, the use of the number of faces detected can enhance the search efficiency. For example, when the user wishes to search for a scene where three persons group together, from the moving image, the starting position of the scene can be easily searched if the condition is set so that a frame where three faces have been detected is searched. If the user registers beforehand the face of his/her own child as the user registration pattern, the frame where the image of the targeted child is picked up can be easily searched if the condition is set so that the frame containing said user registration pattern is retrieved. In particular, such a search function as this will be effective if a still image is to be generated by extracting a best shot from the moving image. This is also effective in the cueing during playback of the moving images or the editing for the moving images.

When the images are displayed on the display unit 17, the number of faces is also displayed, thereby supporting a search task. Users, who are not familiar with the handling of electronic devices, can realize intuitively the position of a frame or scene to be searched, based on the number of faces displayed in association with the time-elapsed bar 32. That is, a desired frame or scene can be easily searched without going through the trouble of complicated operations such as the inputting of search conditions.

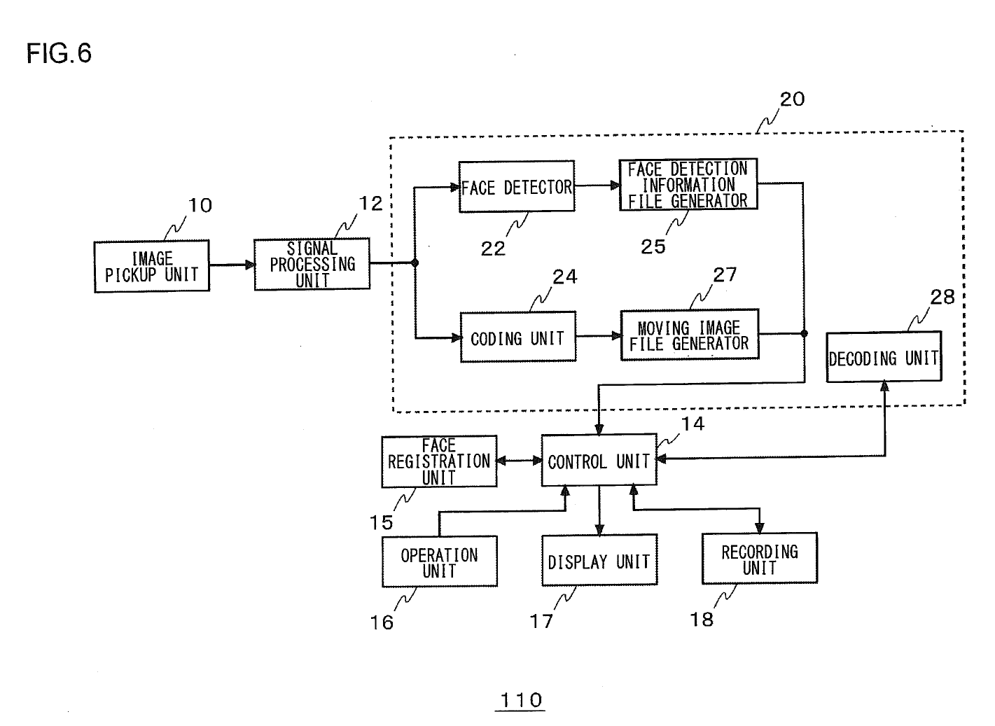

FIG. 6 illustrates a structure of an image pickup apparatus 110 according to a second embodiment of the present invention. Compared with the first embodiment, the image pickup apparatus 110 according to the second embodiment differs in a method for describing the face detection information. The structure of the image pickup apparatus 110 according to the second embodiment is the same as that of the image pickup apparatus 100 according to the first embodiment, except for an image processing unit 20.

The image processing unit 20 according to the second embodiment includes a face detector 22, a coding unit 24, a face detection information file generator 25, a moving image file generator 27, and a decoding unit 28. Thus, the stream generator 26 is not provided here. The face detection information file generator 25 tabulates the face detection information detected by the face detector 22 so as to generate a single or plurality of face detection information files. For example, the identification numbers for frames and the number of faces detected for each frame may be tabulated. The moving image file generator 27 generates a moving image file, such as an MPEG file, from the coded data generated by the coding unit 24. This moving image file and the above-mentioned face detection information file are recorded in a recording unit 18 via a control unit 14. This moving image file and the above-mentioned face detection information file may be recorded in a combined manner such that they are bound together as a single file.

The second embodiment described as above achieves the same advantageous effects as with the first embodiment. In addition, the face detection information is generated as another file. Thus, if the aforementioned moving image file is transmitted, via a wired or wireless transmission channel, from the image pickup apparatus 110 to a playback apparatus 200 described later, the required frames or scenes only can be communicated and therefore the transmission load can be reduced. That is, the image playback apparatus 200 can first receive the aforementioned face detection information file and display the table recorded in the face detection information file. By referring to said table, the user can identify frames or scenes corresponding to a desired search condition. And the image playback apparatus 200 can download said frames or scenes alone from the image pickup apparatus 110.

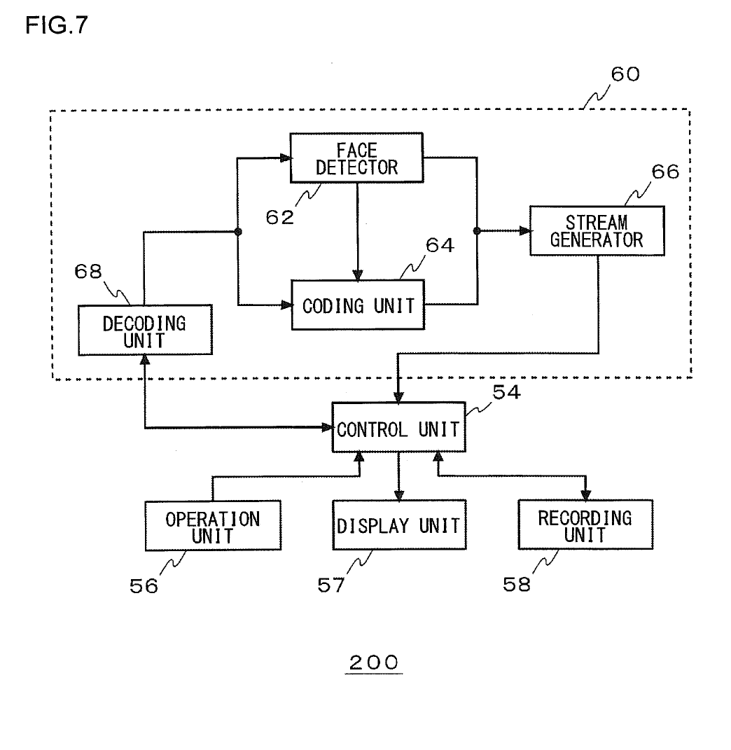

FIG. 7 illustrates a structure of an image playback apparatus 200 according to a third embodiment of the present invention. The image playback apparatus 200 may be an equipment, which has a function of playing back a moving image file, such as a PC, a player that mounts an optical disk drive for a DVD or the like or an HDD, and a set-top box. The playback apparatus 200 according to the third embodiment includes an image processing unit 60, a control unit 54, an operation unit 56, a display unit 57, and a recording unit 58. The image processing unit 60 includes a face detector 62, a coding unit 64, a stream generator 66, and a decoding unit 68.

The decoding unit 68 decodes a codestream to which the face detection information generated by the above-described image pickup apparatuses 100 and 110 is added. The control unit 54 performs such a search or display as described above, based on the decoded face detection information.

Where the codestream added with the face detection information is decoded and reproduced simply, the face detector 62, the coding unit 64 and the stream generator 66 are not required. If the face detector 62, the coding unit 64 and the stream generator 66 are provided, the image processing unit 60 can generate a codestream added with the face detection information, from general codestreams of moving images. That is, the decoding unit 68 decodes the general codestream of moving image so as to be supplied to the face detector 62 and the coding unit 64. Similar to the processing done in the first embodiment, the face detector 62, the coding unit 64 and the stream generator 66 generate the codestream added with the face detection information.

According to the present embodiment described as above, effective applications can be realized by using the face detection information. That is, the use of the number of faces detected can enhance the search efficiency. Also, the general codestreams of moving images are reconstructed to form a codestream added with the face detection information, so that the codestream excellent in search capability can be generated.

The description of the present invention given above is based upon illustrative embodiments. These exemplary embodiments are intended to be illustrative only and it will be obvious to those skilled in the art that various modifications to constituting elements and processes could be developed and that such modifications are also within the scope of the present invention.

Though the face detectors 22 and 62 use the number of faces detected, as the face detection information, in the above-described embodiments, other various parameters may also be used. For example, the size of a face, the position of a face, the level of smile, the presence or absence of redundant data for use in super-resolution processing and the likelihood of a detected face may be used. All or part of these may be used.

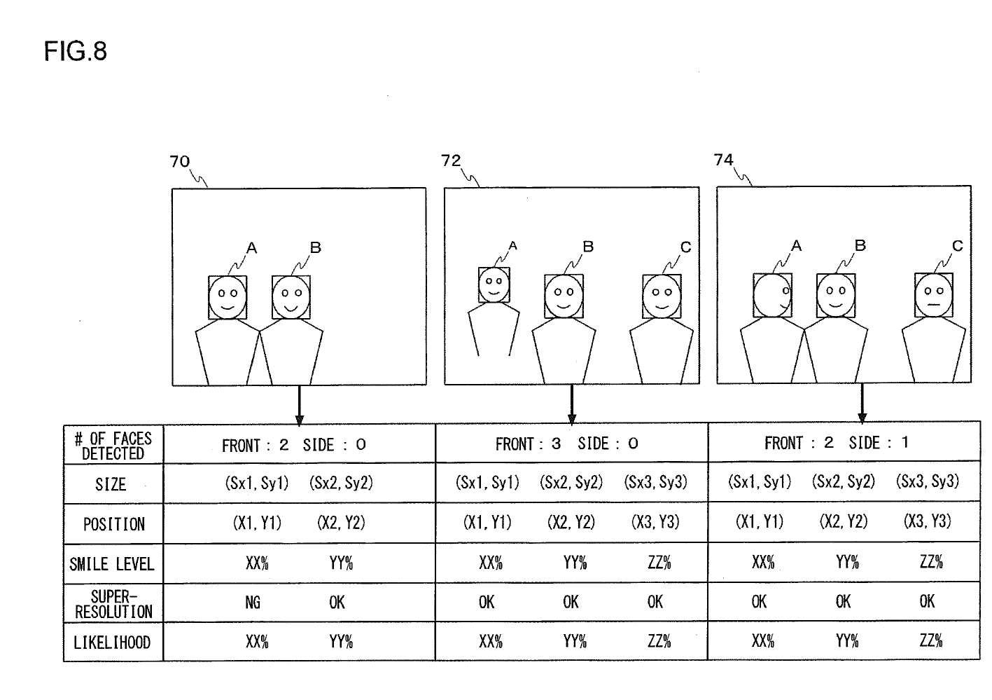

FIG. 8 illustrates an example where face detection information containing a plurality of parameters is generated from images picked up by the image pickup apparatuses 100 and 110 according to the first and the second embodiment. The face detectors 22 and 62 each identifies the number of faces detected, the size of a face, the position of a face, the smile level, the presence or absence of redundant data for use in super-resolution processing and the likelihood of a detected face so as to generate the face detection information for each image.

The face detectors 22 and 62 each identifies the number of detected faces separately for frontal faces and side faces. The face detectors 22 and 62 each identifies the size of a face, the position of a face, the smile level, the presence or absence of redundant data for use in super-resolution processing and the likelihood of a detected face, for each face detected within the same image. In FIG. 8, the face detectors 22 and 62 each identifies the size of a face by the length and the width of a face detection frame. The face detectors 22 and 62 each identifies the position of a face by a predetermined position of the face detection frame, for example, a center point thereof. The face detectors 22 and 62 each identifies the smile level as follows. The face detectors 22 and 62 each verifies a detected face against dictionary data enrolled beforehand for each of different smile levels and identifies the smile level of the dictionary data indicating the highest degree of verification. For example, the face detectors 22 and 62 each identifies the likelihood of a detected face as follows. The face detectors 22 and 62 may set the degree of matching between the detected face and the enrolled dictionary data at the verification, as the likelihood of the face.

The super-resolution processing is a technique where a high-resolution image is generated from a plurality of low-resolution images having displacements from one another. A general method may be used as an algorithm for the super-resolution processing. To perform the super-resolution processing on the face and its peripheral region (hereinafter referred to as “face detection region”), the coding unit 24 codes the redundant data of the face detection region. For example, if the redundant data are added in a temporal direction, the image will be picked up at a high frame rate by the image pickup unit 10, the face detection region will be coded at a high frame rate and the rest will be coded at a normal frame rate. A frame having the face detection region redundantly as compared with the other region can be used as a plurality of low-resolution images having displacements. The face detector 22 identifies whether such redundant data are added by the coding unit 24 to their respective faces or not.

In the above-described embodiments, a description has been given of an example where the number of detected faces is displayed under the time-elapsed bar 32 and the face detection information is used as a search tool. In the following modification, a description will be given of an example where the face detection information is used to generate a moving image digest.

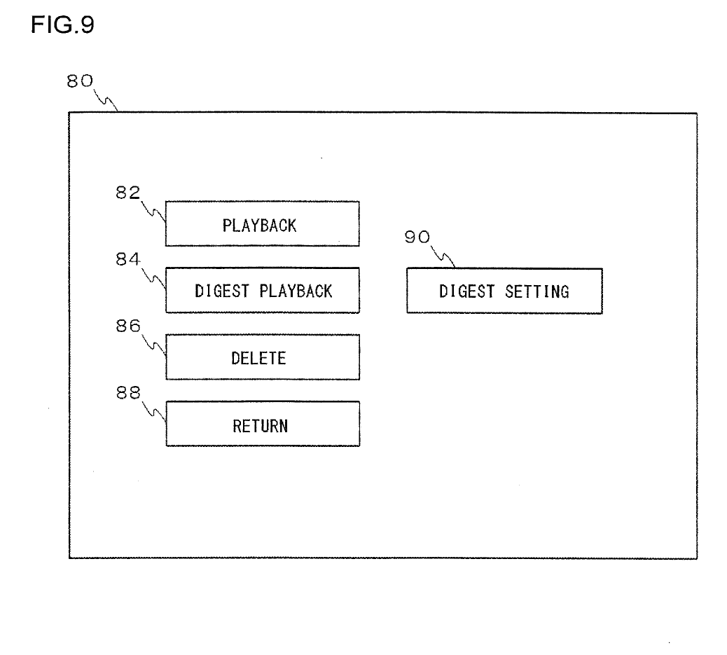

FIG. 9 illustrates an example of an operation screen 80 displayed on the display unit 17 of the image pickup apparatuses 100 and 110 according to the first and the second embodiment or the display unit 57 of the image playback apparatus 200 according to the third embodiment. A playback key 82, a digest playback key 84, a delete key 86, a return key 88 and a digest setting key 90 are displayed on this operation screen 80.

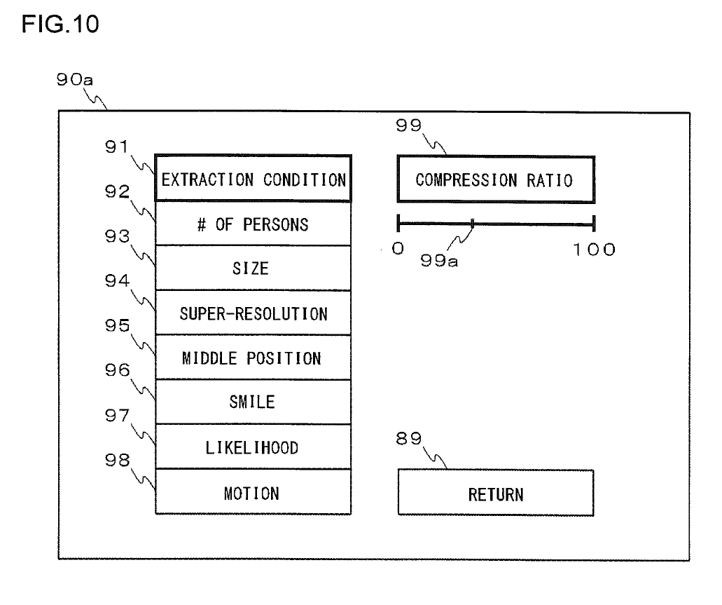

FIG. 10 illustrates an example of a digest setting screen 90a displayed on the display unit 17 of the image pickup apparatuses 100 and 110 according to the first and the second embodiment or the display unit 57 of the image playback apparatus 200 according to the third embodiment. When the user selects the digest setting key 90 within the operation screen 80 by operating on the operation units 16 and 56, this digest setting screen 90a appears.

A number-of-persons key 92, a size key 93, a super-resolution key 94, a middle position key 95, a smile key 96, a likelihood key 97 and a motion key 98 are displayed on this digest setting screen 90a as keys for selecting an extraction condition 91. In addition to these, a compression ratio setting gauge 99a for setting a compression ratio 99 and a return key 89 are displayed.

The extraction condition 91 is referred to when the control units 14 and 54 each generates a moving image digest from the moving images.

When the number-of-persons key 92 is selected, the control units 14 and 54 each extracts pictures the number of which corresponds to a compression ratio from the upper level of pictures having a relatively large number of faces at the time when pictures for digest playback are extracted from the moving images at the compression ratio set by the compression ratio setting gauge 99a. The extracted pictures are connected together to generate a moving image digest. For example, if the compression rate is set to ½, the control units 14 and 54 will each generate a moving image digest whose playback time is a half of the playback time of the entire moving image.

When the size key 93 is selected, the control units 14 and 54 each extracts pictures the number of which corresponds to a compression ratio from the upper level of pictures having faces of a relatively large size at the time when pictures for digest playback are extracted from the moving images at the compression ratio set by the compression ratio setting gauge 99a. The extracted pictures are connected together to generate a moving image digest.

When the super-resolution key 94 is selected, the control units 14 and 54 each extracts, from the moving images, pictures on which the super-resolution processing using the redundant data added at the coding can be performed, and has the extracted pictures undergo the super-resolution processing. Then those pictures are connected together to generate a moving image digest.

When the middle position key 94 is selected, the control units 14 and 54 each extracts pictures the number of which corresponds to a compression ratio from the upper level of pictures close to the middle position of the screen at the time when pictures for digest playback are extracted from the moving images at the compression ratio set by the compression ratio setting gauge 99a. The extracted pictures are connected together to generate a moving image digest. When the smile key 96 is selected, the control units 14 and 54 each extracts, from the moving images, pictures the number of which corresponds to a compression ratio from the upper level of pictures having a high smile level at the time when pictures for digest playback are extracted from the moving images at the compression ratio set by the compression ratio setting gauge 99a. The extracted pictures are connected together to generate a moving image digest.

When the likelihood key 97 is selected, the control units 14 and 54 each extracts pictures the number of which corresponds to a compression ratio from the upper level of pictures having a high face likelihood at the time when pictures for digest playback are extracted from the moving images at the compression ratio set by the compression ratio setting gauge 99a. The extracted pictures are connected together to generate a moving image digest. When the motion key 98 is selected, the control units 14 and 54 each identifies a difference in face position between adjacent pictures, as the motion of a face. When pictures for digest playback are extracted from the moving images at the compression ratio set by the compression ratio setting gauge 99a, pictures the number of which corresponds to the compression ratio are extracted from the upper level of pictures whose motion of the object in relation to previous pictures is relatively larger. The extracted pictures are connected together to generate a moving image digest.

When the user operates on the operation units 16 and 56 and thereby the digest playback key 84 in the operation screen is selected, the control unit 14 and 54 each generates a moving image digest according to a setup condition set as above and has it displayed on the display unit 17 and 57.

It is to be noted that each of the moving image digests generated under a plurality of extraction conditions 91 may be subjected to a logical operation with an AND condition or an OR condition, and the moving image digest obtained after the logical operation may be the final moving image digest. The above-mentioned compression ratio used may be different for each of the extraction conditions.

Though, in the above-described embodiments, human faces are assumed as faces to be detected, faces of animals such as dogs or cats may be detected. In such a case, the above embodiments can be implemented on the same principle therefor if face discriminators for dogs and cats are constructed, respectively.

While the preferred embodiments of the present invention and the modifications to the embodiments have been described using specific terms, such description is for illustrative purposes only, and it is to be understood that changes and variations may be further made without departing from the spirit or scope of the appended claims.

What is claimed is:

1. An image processing apparatus, comprising:
a coding unit which codes a moving image;
a stream generator which generates a codestream from coded data generated by said coding unit; and
an object detector which detects a specific object from within a picture contained in the moving image and which generates, for each picture, object detection information containing at least the number of objects detected within an identical picture,
wherein said stream generator describes the object detection information in a predetermined region of the codestream.

2. An image processing apparatus according to claim 1, wherein said object detector has at least one of a size of the object, a position of the object, the presence or absence of redundant data for use in super-resolution processing, information on whether a user registered object is detected or not and a likelihood of the detected object contained in the object detection information, in addition to the number of objects.

3. An image processing apparatus according to claim 1, wherein the specific object is a face, and
wherein said object detector has the number of faces detected as the object, contained in the object detection information separately for frontal face and side face.

4. An image processing apparatus according to claim 2, wherein the specific object is a face, and
wherein said object detector has the number of faces detected as the object, contained in the object detection information separately for frontal face and side face.

5. An image processing apparatus according to claim 1, wherein the specific object is a face, and
wherein said object detector has a smile level of the face detected as the object, contained in the object detection information, in addition to the number of faces detected as the object.

6. An image processing apparatus according to claim 2, wherein the specific object is a face, and
wherein said object detector has a smile level of the face detected as the object, contained in the object detection information, in addition to the number of faces detected as the object.

7. An image processing apparatus according to claim 1, wherein said stream generator describes the object detection information in a header area or an area, where a write by a user is permitted, of a corresponding picture in the codestream.

8. An image processing apparatus according to claim 7, wherein when the number of objects contained in the object detection information varies, said stream generator describes the object detection information in a header area or an area, where a write by a user is permitted, of a corresponding picture in the codestream; and when the number of objects contained in the object detection information does not vary, said stream generator skips the describing.

9. An image pickup apparatus, comprising:
an image pickup device which picks up a moving image; and
an image processing unit, according to claim 1, which processes the moving image picked up by the said image pickup device.

10. An image processing apparatus for decoding a coded moving image and displaying the decoded image, the apparatus comprising:
a control unit which acquires object detection information, generated for each picture, on a specific object detected within a picture contained in the moving image and which generates a display in a manner that a picture containing the object is identifiable on a temporal axis of the moving image, based on the object detection information; and
a display unit which displays the display generated by said control unit, within a screen.

11. An image processing apparatus according to claim 10, wherein the object detection information includes the number of objects detected within an identical picture, and
wherein said control unit generates the display in a manner that a position in which the number of objects varies is identifiable on the temporal axis of the moving image.

12. An image processing apparatus according to claim 10, wherein the object detection information includes a size of object detected within the picture, and
wherein said control unit generates the display in a manner that a position in which the size of the object is greater than a predetermined set value is identifiable on the temporal axis of the moving image.

13. An image processing apparatus for decoding a coded moving image and displaying the decoded image, the apparatus comprising:
a control unit which acquires object detection information, generated for each picture, on a specific object detected within a picture contained in the moving image and which generates a digest of the moving image, based on the object detection information; and
a display unit which reproduces and displays the digest generated by said control unit.

14. An image processing apparatus according to claim 13, wherein the object detection information includes the number of objects detected within an identical picture, and
wherein when pictures for digest reproduction are extracted from the moving image at a compression ratio set, said control unit extracts pictures the number of which corresponds to the compression ratio, from an upper level of pictures having a large number of objects.

15. An image processing apparatus according to claim 13, wherein the object detection information includes a size of the object detected within the picture, and
wherein when pictures for digest reproduction are extracted from the moving image at a compression ratio set, said control unit extracts pictures the number of which corresponds to the compression ratio, from an upper level of pictures having the object of a large size.
